(19) United States
(12) Patent Application Publication
(10) Pub. No.: US 2006/0115314 A1
(43) Pub. Date: Jun. 1, 2006

(54) Capless writing instrument with closing device

(75) Inventor: Renzo Salvadori, Florence (IT)

Correspondence Address: POLLACK, P.C., THE CHRYSLER BUILDING, 132 EAST 43RD STREET, SUITE 760, NEW YORK, NY, 10017, US

(73) Assignee: Stipula Firenze S.r.l.

(21) Appl. No.: 11/246,323

(22) Filed: Oct. 6, 2005

(30) Foreign Application Priority Data
Oct. 6, 2004 (IT) FI2004A000205

(51) Int. Cl. B43K 7/12; B43K 24/02

(52) U.S. Cl. 401/108; 401/107

(57) ABSTRACT

A capless writing instrument with a retractable nib is disclosed. The instrument includes an external tubular housing, a writing unit carrying the nib, an ink feed and a sliding ink reservoir mounted inside the housing, and elements for controlling axial movement of the writing unit inside the housing. One end of the external tubular housing is closed partially by a fixed wall integral therewith. An internal tubular housing mounted axially and pivotally inside the external tubular housing, in turn, slidably mounts the writing unit operating internally thereto. A mobile wall integral with the internal tubular housing is positioned at an end of the external tubular housing complementary in shape to that of the fixed wall, so as to close such end completely in a first operating position and to open it partially in a second operating position, in order to allow the nib to pass therethrough following axial rotation of the internal tubular element controlled by the elements for controlling axial movement of the writing unit.

### FIELD OF THE INVENTION

The present invention relates generally to writing instruments and, more particularly, to fountain pens of the capless type.

### BACKGROUND OF THE INVENTION

Conventional capless writing instruments such as fountain pens typically comprise a writing unit with a nib, an ink feed and a corresponding reservoir that slide along a passage inside the barrel of the pen so as to allow the nib to extend from one end of the barrel. In order to prevent ink from drying out when the pen is not in use, namely, when the nib is in a retracted position, the passage opening at the one end of the pen must be closed while capable of being opened at the time of use. Usually, the nib extends from the barrel by pressing a button at the opposite end of the barrel, via a mechanism common to ballpoint pens. In this arrangement, the exit passage of the nib is kept closed, when not in use, using a shutter that goes up when flexibly pushed by its support or the feeder of the nib and comes down again when the nib retracts.

In a desire to design a fountain pen without a cap and therefore with a retractable nib, there is the problem of how to control the sliding mechanism of the nib holder and the necessary closing device. The solution to this problem must then be compatible with structural simplicity, the aesthetics of the pen and ease of use.

### OBJECTS AND SUMMARY OF THE INVENTION

Accordingly, it is an object of the present invention to provide a capless fountain pen that achieves the functional and aesthetic requirements mentioned above.

This object is achieved with the capless fountain pen according to the present invention, the main characteristic of which is the fact that the external tubular housing has one of its ends partially closed with a fixed wall integral with it and an interal tubular housing, inside which the said writing unit is slidably housed, is mounted slidably and pivotally within the external tubular housing. A mobile wall integral with the internal tubular housing is also provided, positioned at the end of the external tubular element and complementary in shape to that of the fixed wall, so as to completely close the end in one of its first operating positions or to open it partially, to enable the nib to pass through, in a second operating position, following an axial rotation of the internal tubular element controlled by the same control means of the axial movement of the writing unit. In this way the action which the user exerts to move the writing unit axially causes first the rotation of the mobile wall and then the opening of the pasasage for the nib at the end of the barrel of the pen.

In particular, the control means of the axial movement of the writing unit may be substantially of the bayonet type with a sleeve having a radially protruding element and with the internal tubular housing which also has a longitudinal slot within which the protruding element slides. The external tubular housing in turn has a longitudinal slot and a perimeter slot extending from it by an amplitude equal to the angle of axial rotation, when the nib is in the retracted position the protruding element being engaged in the perimeter slot, whereby, by making the protruding element slide in the slot, the internal tubular housing rotates axially until the two longitudinal slots are on top of each other, and then by making the protruding element slide inside them, the axial sliding of the writing unit and the emergence/retraction of the nib is produced.

### BRIEF DESCRIPTION OF THE DRAWINGS

A specific, illustrative capless fountain pen, according to the present invention, is described below with reference to the accompanying drawings, in which:

FIG. 1 shows a longitudinal section of a fountain pen, according to one aspect of the present invention, with the nib in a retracted or stowed position;

FIG. 2 shows a longitudinal section of the pen set forth in FIG. 1, with the nib in an extended or operative position;

FIG. 3 is a front view of the pen along arrow F in FIG. 1;

FIG. 4 is a side view of an external housing of the pen illustrated in FIG. 1;

FIG. 5 shows a longitudinal section of an internal rotating housing of the pen set forth in FIG. 1;

FIG. 6 shows a longitudinal section of a fountain pen, according to another aspect of the present invention, with the nib in a retracted or stowed position; and

FIG. 7 shows a longitudinal section of the pen set forth in FIG. 6, with the nib in an extended or operative position;

The same numerals are used throughout the drawing figures to designate similar elements. Still other objects and advantages of the present invention will become apparent from the following description of the preferred embodiments.

### DETAILED DESCRIPTION OF THE PREFERRED EMBODIMENTS

Referring now to the drawings and, more particularly, to FIGS. 1-7, there is shown generally a specific, illustrative writing instrument, in accordance with various aspects of the present invention. According to one embodiment, shown generally in FIGS. 1-5, a fountain pen is provided which comprises an external tubular housing 1, forming the barrel of the pen, with a half-closed end by a substantially semi-circular fixed wall 1a, and an internal tubular housing 2 co-axially and pivotally mounted inside the external tubular housin. One end of internal tubular housing 2 abuts wall 1a and, in turn, is partially closed by a mobile wall 2a, which is substantially semi-circular in shape and, therefore, complementary to that of fixed wall 1a. Inside the internal tubular housing, a sleeve 3 is mounted for axial sliding movement and to carry a writing unit 4. The sleeve comprises an ink feeder 5 from which the nib axially extends. The sleeve is preferably joined from an opposite side to an ink reservoir 6, such as a replaceable type ink cartridge.

The external tubular housing 1 has a circumferential slot 7 extending for a certain length, in particular through 180°, near the end opposite to that where the wall 1a is situated and on a plane perpendicular to the axis of housing 1. Circumferential slot 7 ends in a longitudinal slot 8 of the external tubular housing 1 extending from the same end, up to approximately half-way along the entire length. Internal tubular housing 2 also has a longitudinal slot 9 extending from the end opposite to that where wall 2a is situated up to approximately half-way along its entire length. From sleeve 3 there also extends a radially protruding element 10 engaged in slot 9 of internal tubular housing 2.

Longitudinal slot 9 is provided at the diametrically opposed end with respect to wall 2a provided at the other end of internal tubular housing 2. Similarly, longitudinal slot 8 is provided at the diametrically opposed end with respect to wall 1a formed at the other end of external tubular housing 1. In this way, when slots 8 and 9 lie diametrically opposed to the central axis, wall 2a completely closes the open part of the end of external tubular housing 1a not covered by wall 1a.

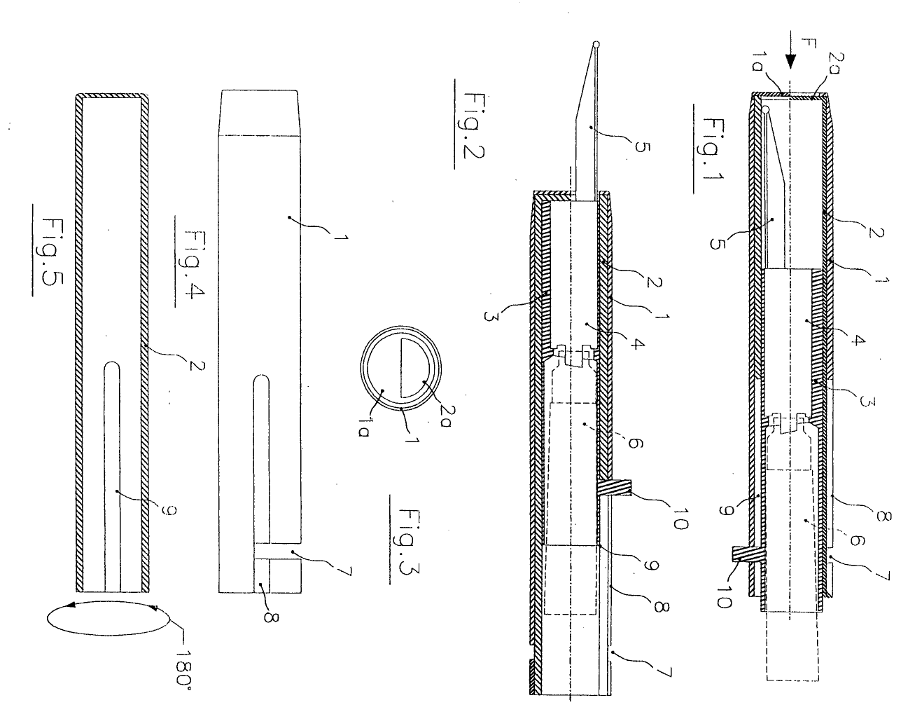

When the nib 5 is completely retracted as shown in FIG. 1, the radially protruding element 10 is engaged both in longitudinal slot 9 and in circumferential slot 7, at the end opposite to that in which the said slot runs into longitudinal slot 8 of external tubular housing 1. By making radially protruding element 10 of sleeve 3 slide from one end to the other of circumferential slot 7, a corresponding rotation of internal tubular housing 2 is caused to occur and wall 2a displaces from the position indicated in FIG. 1 to that in FIG. 2 in which it lies near and behind wall 1a, leaving the passage clear for the nib 5.

Following the rotation of internal tubular housing 2, the longitudinal slot 9 is in radial alignment with longitudinal slot 8, whereby radially protruding element 10 can be moved axially along the slots causing the sleeve 3 to axially slide inside internal tubular housing 2 with the resulting emergence of the nib 5 through the passage left free by wall 2a. To retract the nib inside internal tubular element 2 and close the latter, it is necessary to take the reverse action on radially protruding element 10 in order to bring it back at the closed end of circumferential slot 7.

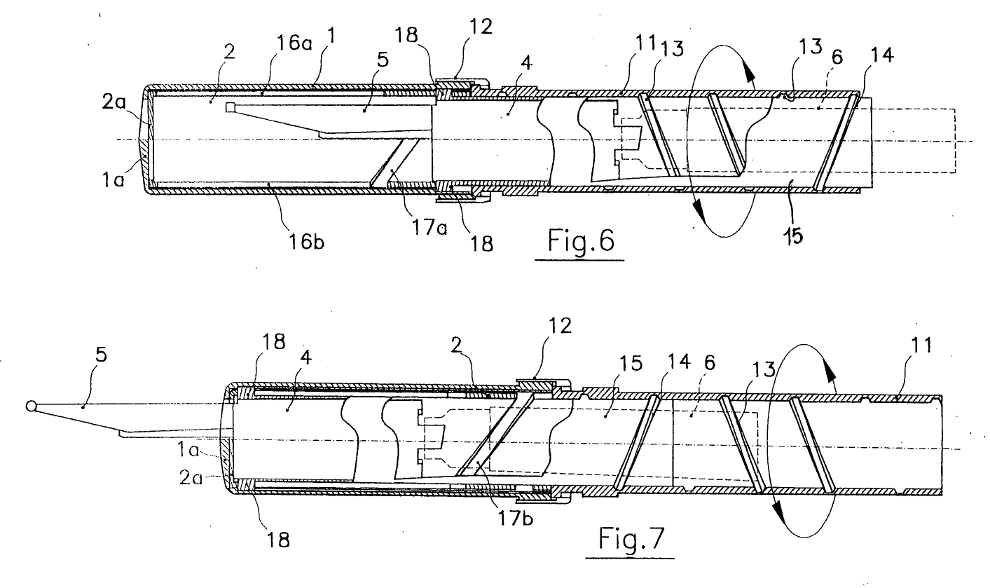

According to a different embodiment of the invention, illustrated in FIGS. 6 and 7, a different control system is used to cause the coming out and retraction of the nib 5 to occur. In the two embodiments illustrated, the same components are marked with the same reference numbers.

With reference to the FIGS. 6 and 7, the external tubular housing 1, provided with fixed wall 1a at its end, is aligned axially to an external sleeve 11 end-to-end connected to external tubular housing 1 by means of a threaded ring 12 in such a way that it can be rotated freely on its axis. Inside sleeve 11 there is a helicoidal groove 13 and a corresponding helicoidal projection 14 formed on an internal sleeve 15 carrying the writing unit 4 with the nib 5 and the ink cartridge 6 is engaged in groove 13. Inside external tubular housing 1 there is, as in the previous embodiment of the invention, the internal tubular housing 2 provided at its end, abutting on fixed wall 1a, with a mobile closure wall 2a. The internal tubular housing 2 is pivotally mounted in external tubular housing 1 and has a pair of longitudinal slots 16a, 16b formed on diametrically opposed parts and extending from an intermediate part thereof to the end provided with mobile wall 2a. From the two longitudinal slots 16a and 16b run two respective helicoidal slots 17a and 17b extending from diametrically opposed parts, and in opposite directions, along the side surface of internal tubular housing 2.

From the front end of internal sleeve 15, the one from which the nib 5 extends, there extend two radial teeth 18 from diametrically opposed parts, which guide the movement of internal sleeve 15 within internal tubular housing 2. More specifically and as shown in FIG. 6, when the nib 5 is in the retracted position in internal tubular housing 2, the two radial teeth 18 are positioned at the ends of helicoidal slots 17a and 17b. Rotating external sleeve 11 through 180°, internal sleeve 15 is caused to advance and being bound to internal tubular housing 2 through its teeth 18 being engaged first in helicoidal slots 17a, b and then in the longitudinal slots 16a, b, cannot rotate but only slide axially, instead making internal tubular housing 2 rotate 180° until the teeth 18 run through helicoidal slots 17a, b. In this way the closure wall 2a passes from the position shown in FIG. 6 to that in FIG. 7 in which it lies in a position near and behind wall 1a leaving the passage for the nib 5 clear.

In the present embodiment of the invention the pen will necessarily be longer than the one described previously and illustrated in FIGS. 1-5, in that in this case the nib 5 advances while the internal tubular housing rotates through 180°, whereby the two internal and external tubular housings must have an additional lenght sufficient to prevent the nib 5 interfering with wall 2a while it is rotating, before the latter has reached its final position shown in FIG. 7.

In each case, owing to the present invention, it is possible to make fountain pens of shorter length and which are extremely easy to use even using only one hand to extract and retract the nib.

Although the present invention is shown and described in connection with a particular schematic representation of a fountain pen and its external structure, it will be appreciated by those skilled in the art that the invention may be incorporated into other pen designs and configurations according to the aesthetic choices of the designer and the models, within the spirit and scope of the invention.

Various modifications and alterations to the invention may be appreciated based on a review of the disclosure. These changes and additions are intended to be within the scope and spirit of the invention as defined by the following claims.

What is claimed is:

1. A capless writing instrument having a retractable nib, the instrument comprising an external tubular housing, a writing unit carrying the nib, an ink feed and a sliding ink reservoir mounted inside the housing, least one element for controlling axial movement of the writing unit in the housing, the external tubular housing having one of its ends partially closed by a fixed wall integral thereto, and an internal tubular housing slidably and pivotally housed in the external tubular housing, the writing unit being slidably mounted in the internal tubular housing, the internal tubular housing being formed with a mobile wall positioned at the end of the external tubular housing and complementary in shape to that of the fixed wall, so as to close the end in a first operating position or to open it partially, in a second operating position, so as to allow the nib to pass therethrough following axial rotation of the internal tubular element controlled by the at least one element for controlling axial movement of the writing unit.

2. The instrument set forth in claim 1, wherein the control elements comprise a sleeve, arranged in the internal tubular housing and to which the writing unit is mounted, the sleeve having a radially protruding element, the internal tubular housing also having a longitudinal slot inside which the protruding element is slidably engaged, the external tubular housing including a longitudinal slot and a perimeter slot extending therefrom by an amplitude equal to the angle of the axial rotation, such that when the nib is in the retracted position, the protruding element is also engaged in the perimeter slot, whereupon, by causing the protruding element to slide in the slot, axial rotation of the internal tubular housing is produced until the two longitudinal slots lie on top of one another and, thereby, causing the protruding element to slide into the slots, the axial sliding of the writing unit and emergence of the nib from the pen barrel is produced.

3. The instrument set forth in claim 2, wherein the longitudinal slots extend from the ends of the housings opposite the ends carrying the fixed and mobile walls up to an intermediate point of the housings, and are located on sides axially opposite to the respective walls.

4. The instrument set forth in claim 1, wherein axial rotation of the internal tubular housing and the perimeter slot has an amplitude of approximately 180°.

5. The instrument set forth in claim 1, wherein when the nib is in the retracted position, the longitudinal slot of the external tubular housing and the longitudinal slot of the internal tubular housing are arranged on diametrically opposed sides relative to the axis.

6. The instrument set forth in claim 1, wherein the control element includes an internal sleeve, arranged on inside portions of the internal tubular housing and to which the writing unit is mounted, with an external helicoidal projection, the external tubular housing being connected axially and pivotally to one end of an external sleeve having an internal helicoidal groove on inside portions thereof with which the helicoidal projection is slidably engaged, the internal tubular housing including at least one longitudinal slot that extends up to the end carrying the mobile wall and at least one second helicoidal slot extending from the internal end of the longitudinal slot, the internal sleeve having at least one radial tooth that, when the nib is in the retracted position, is engaged in the second helicoidal slot, whereupon rotation of the external sleeve about its own axis, the tooth slides inside the second helicoidal slot, resulting in axial rotation of the internal tubular housing, and then slides inside the longitudinal slot, resulting in emergence of the nib from the pen barrel.

7. The instrument set forth in claim 6, wherein the internal tubular housing has two longitudinal slots on opposite sides thereof and two second helicoidal slots on opposite sides that extend from the internal ends of the slots, the internal sleeve having two radial teeth engaged slidingly inside the slots.

8. The instrument set forth in claim 6, wherein the axial rotation and the second helicoidal slots have an amplitude equal to approximately 180°.

9. The instrument set forth in claim 6, wherein the external sleeve is connected to the external tubular housing by a ring screwed to the housing so as to tighten the ends of the housing and the external sleeve axially, thereby enabling free axial rotation of the sleeve.
